(19) United States
(12) Patent Application Publication
(10) Pub. No.: US 2026/0276125 A1
(43) Pub. Date: Sep. 17, 2026

(54) Hot Tapping System with Portable Hot Tapping Tools

(71) Applicant: Dedicated Customs Inc., Washington, PA (US)

(72) Inventor: Matthew Smiley, Burgettstown, PA (US)

(21) Appl. No.: 19/552,726

(22) Filed: Feb. 27, 2026

Related U.S. Application Data
(60) Provisional application No. 63/764,304, filed on Feb. 27, 2025.

(51) Int. Cl. F16L 41/06

(52) U.S. Cl. CPC F16L 41/06

(57) ABSTRACT

A hot tapping system includes a branch pipe portion; a saddle clamp coupled to the pipe portion and to a run line; a valve coupled to the branch pipe portion; and a portable hot tapping tool including a lower housing, intermediate T-housing and upper housing, and a telescoping drive shaft with a drilling bit for selectively breeching the run line and a drive connection, wherein the drive shaft extends longitudinally through the lower housing, intermediate T-housing, and upper housing, with the drive shaft sealed against the upper housing, whereby only the lower housing and intermediate T-housing is pressurized following breeching of the run line; wherein the lower housing is configured to be selectively coupled to the valve, and wherein the intermediate T-housing includes at least a bleed valve for depressurizing the lower housing and intermediate T-housing.

### RELATED APPLICATION

The present claims priority to of U.S. Provisional Patent Application 63/764,304 filed Feb. 27, 2025, titled “Hot Tapping System with Portable Hot Tapping Tool” which application and publication are incorporated herein by reference.

### BACKGROUND OF THE INVENTION

### 1. Field of the Invention

The present invention relates to tool for adding a branch connection to a pressurized line, more particularly to hot tapping system with portable hot tapping tool for adding a branch connection to a pressurized line.

### 2. Background Information

In fluid handling art, a hot tap or hot tapping is a method for adding a branch connection to a “hot” or operating pressurized line. The hot tapping process allows a connection into a pressurized in-service operating system, by drilling or cutting. The hot tap procedure generally involves attaching a branch connection and valve on the outside of an operating pipeline, and then cutting out the pipeline wall within the branch, and removing the wall section through the valve.

In general, hot taps are done in a piping system, however it can also be done on pressure vessels and storage tanks, such as to add nozzles. Hot tapping methods to date have been described as highly dangerous operations. Therefore, hot tapping historically has been allocated as only to be used as the last resort when it is impractical or impossible to shut down the system. Typically in these last resort applications there is significant time and effort placed into preparing a hot tapping specification for the particular job. Generally there has been an understanding with current hot tapping methods substantial care needs to be exercised in inspection, design, and testing and that each hot tapping needs to be meticulously designed, the location of hot tapping thoroughly inspected, and the installation procedures reviewed before starting the operation. With this understanding, hot tapping is deemed an expensive last resort.

There are, however, several economic and environmental benefits to using a hot tap instead of a system shut down. Hot tapping avoids releasing the fluid (pressurized liquid or gas) into the environment and doesn't interrupt service of the line. Additionally, it can avoid time consuming cutting, realignment, and resealing of pipeline sections and reduce costs associated with planning and coordinating a complete system or section shut down.

There remains a need in the art to provide a hot tapping system avoiding the drawbacks of the prior art.

### SUMMARY OF THE INVENTION

The various embodiments and examples of the present invention as presented herein are understood to be illustrative of the present invention and not restrictive thereof and are non-limiting with respect to the scope of the invention.

It is an object of the present invention to eliminate the above-mentioned drawbacks by providing a hot tapping system includes a leading branch pipe portion; a saddle clamp coupled to the leading branch pipe portion having a saddle-shaped base with a clamp mechanism configured to securely fasten the saddle clamp to a run line, configured to provide a secure and leak-free connection with the leading branch pipe portion; a valve coupled to the leading branch pipe portion; and a portable hot tapping tool including a lower housing, intermediate T-housing and upper housing, and a telescoping drive shaft with a drilling bit at a distal end of the telescoping drive shaft for selectively breeching the run line and with a drive connection at a proximal end of the drive shaft, wherein the drive shaft extends longitudinally through the lower housing, intermediate T-housing, and upper housing, with the drive shaft fluidly sealed against the upper housing, whereby only the lower housing and intermediate T-housing is pressurized following breeching of the run line; wherein the lower housing is configured to be selectively coupled to the valve, and wherein the intermediate T-housing includes at least a bleed valve for depressurizing the lower housing and intermediate T-housing following breeching of the run line.

One aspect of the invention provides a portable hot tapping tool comprising a lower housing; an intermediate T-housing including at least a bleed valve; an upper housing; and a telescoping drive shaft with a drilling bit at a distal end of the telescoping drive shaft for selectively breeching a run line and with a drive connection at a proximal end of the drive shaft, wherein the drive shaft extends longitudinally through the lower housing, intermediate T-housing, and upper housing, with the drive shaft fluidly sealed against the upper housing, whereby only the lower housing and intermediate T-housing is pressurized following breeching of the run line; wherein the lower housing is configured to be selectively coupled to the valve, and wherein the bleed valve is configured for depressurizing the lower housing and intermediate T-housing following breeching of the run line.

One aspect of the invention provides A method of hot tapping a run line comprising the steps of: A) Providing a hot tapping system comprising: i) A leading branch pipe portion; ii) A saddle clamp coupled to the leading branch pipe portion having a saddle-shaped base with a clamp mechanism; iii) A valve coupled to the leading branch pipe portion; and iv)A portable hot tapping tool including a lower housing, intermediate T-housing and upper housing, and a telescoping drive shaft with a drilling bit at a distal end of the telescoping drive shaft for selectively breeching the run line and with a drive connection at a proximal end of the drive shaft, wherein the drive shaft extends longitudinally through the lower housing, intermediate T-housing, and upper housing, with the drive shaft fluidly sealed against the upper housing, B) securing the leading branch pipe portion tightly to the run pipe exterior with the saddle clamp to provide a secure and leak-free connection with the leading branch pipe portion; C) securing the valve coupled to the leading branch pipe portion and the portable hot tapping tool to the valve; D) Operating the hot tapping tool to breach the run pipe, whereby the lower housing and intermediate T-housing is pressurized following breeching of the run line; E) Closing the valve; F) Depressurizing the lower housing and intermediate T-housing following breeching of the run line via a bleed line in the T-housing; G) Removing the portable hot tapping tool from the valve; and H) Coupling branch pipe elements to the valve and opening the valve.

These and other advantages of the present invention will be clarified in the description of the preferred embodiments taken together with the attached figures.

### BRIEF DESCRIPTION OF THE FIGURES

FIG. 1A is a view of the branching elements attached to a run line in the hot tapping system of the present invention.

FIG. 1B is an illustration of the hot tapping system of the present invention.

FIG. 2 is an illustration of the hot tapping tool of FIG. 1 with a second upper housing and bushing illustrated for clarity.

FIG. 3 is a schematic illustration, partially in cross section of the hot tapping tool of FIG. 2.

FIG. 4 illustrates a power tool operating the hot tapping tool of the present invention.

FIG. 5 is a view of a possible sealing member used in the hot tapping tool of the present invention.

FIG. 6 is a view of a possible sealing wet tap body and coupler for coupling to the branching elements of the present invention.

### DESCRIPTION OF THE PREFERRED EMBODIMENTS

The hot tapping system 10 of the present invention is disclosed in connection with piping as is often used in the oil and gas industry for transporting fracking fluid. The hydraulic fracturing process, or fracking, efficiently extracts crude oil and gas trapped in shale rock formations.

Hydraulic fracturing operations involve drilling a vertical well typically at least a mile below the earth's surface down to the shale rock, followed by gradual horizontal drilling that could continue for thousands of feet. Tiny holes or perforations are made at the end of the horizontal leg through which a mixture of water (90%), frac sand (9.5%), and chemicals (0.5%) is injected at high pressure. Once the pressure is released, oil and natural gas rush to the surface for extraction.

Hydraulic fracturing requires a number of expensive equipment such as high-pressure and high-volume fracking pumps, blenders for making the fracking fluids, storage tanks for storing the fracking fluids and components therefore, and piping to transport these materials to, from, and among this equipment sometimes over a considerable distance. In the field, it is often desirable to add a branch line to an existing system, or to add additional equipment in line, such as a storage tank, new fluid processing equipment, or other desired system modification. In this application the hot tapping system 10 is particularly beneficial to avoid taking a section offline and draining a portion thereof requiring proper disposal of a significant amount of fracking fluid (which has special handling requirements).

The pipe into which a hot tap is to be made in the hot tapping system 10 of the present invention is called the run pipe 12 while the pipe which is to be connected to the run pipe 12 by the hot tap is called the branch pipe. The run pipe 12 used in the oil and gas industry is generally a plastic pipe. Specifically run pipe 12 may be any common non-metallic pipe such as a Glass Fiber Reinforced Plastic Pipe or GRP pipe which have superior qualities such as corrosion resistance, being light weight, allowing a smooth bore and maintaining stability in longer sections. Alternatively the run pipe 12 may be a FRE pipe reinforced by high-strength glass fibers embedded in an epoxy matrix. GRE Pipes (Glass reinforced epoxy) are also known as corrosion resistant pipes that can form the run pipe 12. The hot tapping system 10 as described herein is designed for non-metallic run pipe 12, as the system 10 is designed to accommodate the removal of the material forming the hot tap in the non-metallic run pipe. Metal pipes would require a distinct drill and material removal concerns.

The branch pipe formed with the system 10 may be for creating an entirely new pressurized line or for coupling a pipeline accessory such as a pressure gauge, sample port, storage reservoir, bleed valve, fluid processing equipment or the like.

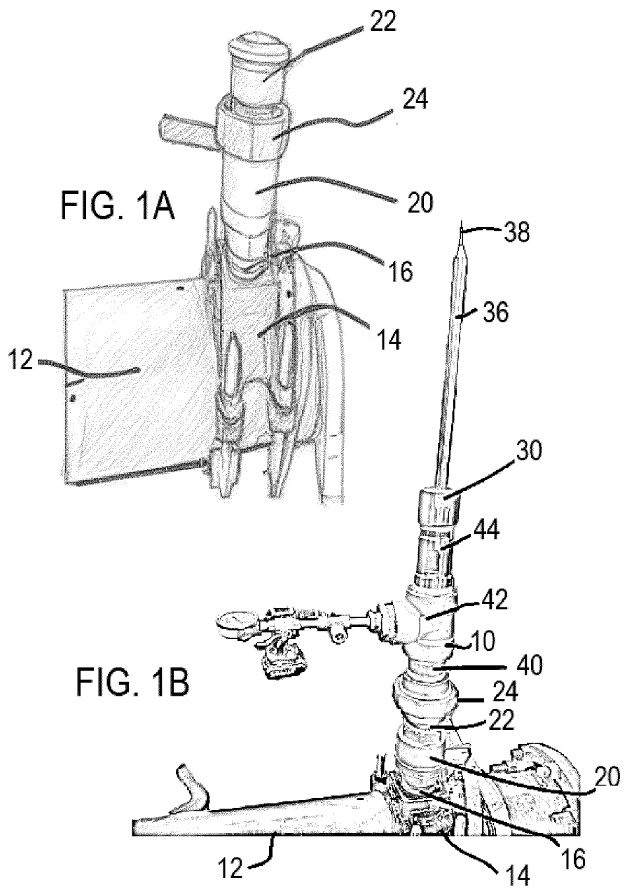

The initial connection of the branching elements of the system 10, shown best in FIG. 1A, to the existing run pipe 12 is made via a fitment, here comprising a full-encirclement saddle clamp 14 which wraps completely around the run pipe 12 and clamps tightly thereto, securing the leading branch pipe portion 16 securely and tightly to the run pipe 12 exterior. The full-encirclement saddle clamp 14 and leading branch pipe portion 16 are often used in cold tapping scenarios where the run line 12 is taken offline and depressurized. The saddle clamp 14 consists of a saddle-shaped base with a clamp mechanism that securely fastens the saddle clamp 14 to the main pipe or run line 12, allowing for a secure and leak-free connection with the leading branch pipe portion 16.

Coupled to the leading branch pipe portion 16 is a valve 20. Valve 20 is on the hot tap connection and can effectively be either a block valve or a control valve for the new the branch pipe. A control valve is an automated valve that can make precise adjustments to regulate and monitor any commodity flowing through a piping system. The function of a control valve is to provide throttling control in response to signals from a control system, using an actuator and a positioner. Suitable valves 20 include a ball valve or gate valve, but generally not a plug valve or butterfly valve, because of the need to have access through the valve 20 for the hot tapping tool 30.

Attached to the valve 20 is a line coupler 22 with locking nut 24 which is configured to attach to the remaining portions of the branch pipe, such as for creating an entirely new pressurized line or for coupling a pipeline accessory such as a pressure gauge, sample port, storage reservoir, bleed valve, fluid treatment equipment or the like. Thus the branch pipe consists of the saddle clamp 14, the leading branch pipe portion 16, the valve 20, the line coupler 22 with locking nut 24, and the new pressurized line or the pipeline accessory (not shown). The saddle clamp 14, the leading branch pipe portion 16, the valve 20, and the line coupler 22 with locking nut 24 combine to form the branching elements of the system 10 of the invention, which are left behind in the branch line after hot tapping is completed.

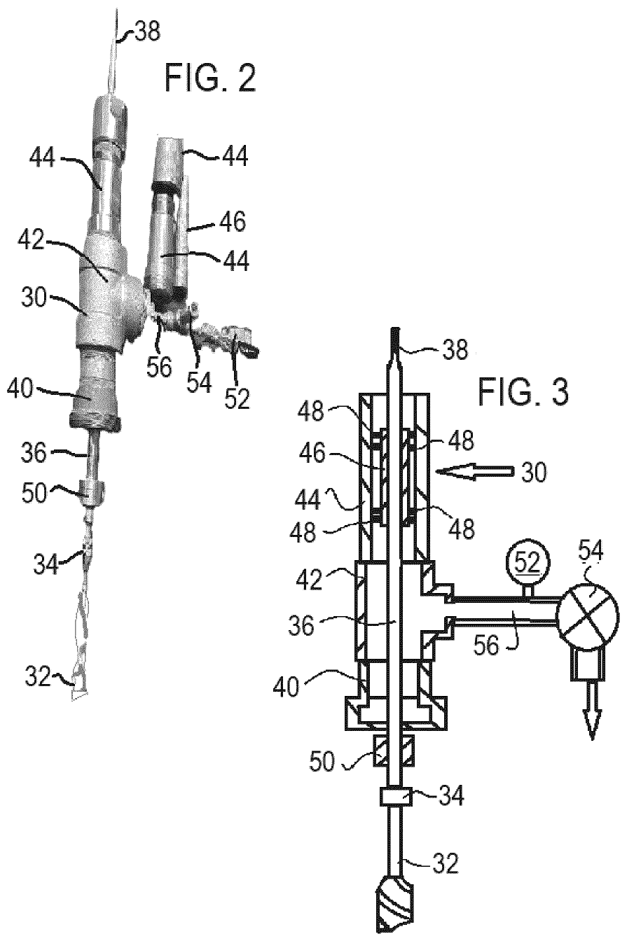

The hot tapping system 10 of the present invention includes a portable hot tapping tool 30, shown schematically in FIG. 3 and in detail in FIGS. 1B, 2 and 4, comprising a replaceable drilling bit 32 couples with a quick release connection 34 to a distal end of a sliding or telescoping drive shaft 36. The drive shaft 36 has a drive connection 38 (such as a hex style drill connection) at a proximal end of the shaft 36 to be selectively engaged with a power source such as a hand drill. The drive shaft 36 extends through a lower housing 40, intermediate T-housing 42 and upper housing 44 as well as through a cylindrical bushing 46 within the upper housing. Sliding or telescoping of the drive shaft 36 within the context of this application references the ability of the drive shaft 36 to move axially or longitudinally relative to the lower housing 40, intermediate T-housing 42 and upper housing 44. The drive shaft 36 extends along the longitudinal or axial direction of the hot tapping tool 30.

The upper housing 44 is sealed against the cylindrical bushing 46 with a plurality of radial seals 48 (with one seal shown in FIG. 5 for clarity), and the cylindrical bushing 46 seals against the sliding shaft 36 with a metal to metal seal (or alternatively added radial seals). The elongate bushing 46 has a tight tolerance with the shaft 36 (1/1000″) which yields an effective metal to metal seal, but it also maintains alignment of the shaft 36 in operation for proper positioning of the drill tip 32 as well as preventing uneven pressure on the seals 48. The elongated cylindrical brass bushing 36 may be 5-6″ in length and be quite effective. The drive shaft 36 further includes a stop member 50 coupled thereto that limits the upward movement of the shaft 36 when it impinges upon lower portions of the upper housing 44.

The T-housing 42 is fluidly coupled to a pressure gauge 52 and bleed valve 54 via T-line 56. The pressure gauge 52 and valve 54 are preferably coupled such that the pressure gauge 52 properly reads the pressure within the T-housing 42 and lower housing 40 regardless of the position of the valve 54. The term T-housing defines any conventional housing with aligned inlet and outlet (to allow the shaft 32 to telescope there through) and a branching line formed therein. A T-shaped branching line, as shown, is preferred because the 90 degree orientation allows the branch line for the bleed valve 54 and gauge 52 to be out of the way of the remaining portions of the tool 30. A modified “Y” shaped connector (with the inlet and outlet aligned to accommodate the shaft 32) could also work and be equally effective and thus is still considered as a type of T-housing 42 within the meaning of this application. The lower housing 40 is configured to be selectively coupled to the line coupler 22 with the locking nut 24.

In operation the initial connection to the existing run pipe 12 is made via the full-encirclement saddle clamp 14 which wraps completely around the run pipe 12 and clamps tightly thereto, securing the leading branch pipe portion 16 securely and tightly to the run pipe 12 exterior.

The leading branch pipe portion 16 is angled in the desired take off orientation of the branch pipe. The hot tapping system 10 of the present invention gives great flexibility to the angle of the branch pipe with only the clearance of the portable hot tapping tool 30 and driving drill being the limiting factors. Thus the use can select almost any direction perpendicular to the run line 12 a full 360 degrees about the run line 12.

The valve 20 is secured to the leading branch pipe 16 and the inline line coupler 22 with locking nut 24 are secured to the valve 20 completing the branching elements of the system 10 as shown in FIG. 1A. The valve 20 and line coupler 22 may be attached to before or after the saddle clamp 14 is placed in position.

The drilling bit 32 of the hot tapping tool 30 is selected as desired for the desired port size. With the branching elements of the system 10 (e.g., saddle clamp 14, leading branch pipe portion 16, valve 20 and the inline line coupler 22 with locking nut 24) in position the portable hot tapping tool 30 is secured to the coupler 22 with the locking nut 24 engaging via threads with the lower housing 40. The valve 20 may now be opened.

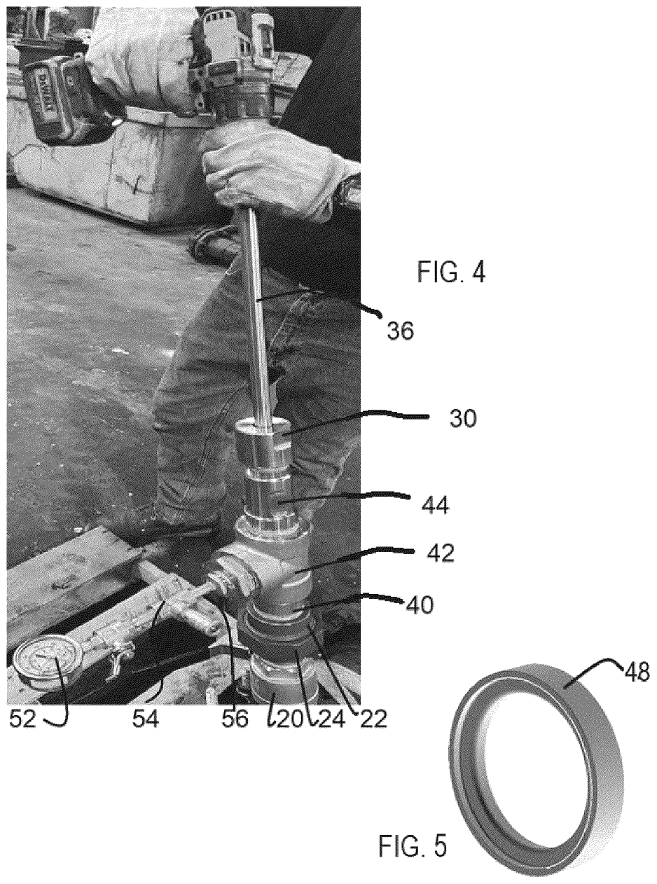

A power drill is coupled to the drive connection 38 at the proximal end of the shaft 36 as shown in FIG. 4 and the shaft 36 is advanced to engage the drilling bit 32 with the run pipe 12, operating the power drill will allow the drill bit 32 to engage with and breech the run pipe 12 forming the branch pipe opening. The drilled material of the run pipe 12 forming the tapped opening will typically be entangled with and stay with the drill bit 32 and be removed with the drill bit 32.

Once the pressurized run pipe 12 is breeched with the drill bit 32 the lower housing 40 and T-housing 42 will be pressurized. The operator will often feel the breech being formed as the bit 32 advances but can confirm the breech by the indication on the pressure gauge 52. With the drive shaft 32 fluidly sealed against the upper housing 44 via bushing 46 and radial seals, only the lower housing 40 and T-housing 42 of the hot tapping tool 30 will be pressurized and filled with fluid. Once the opening has been formed the shaft 36, bit 32 (with drilled material) is withdrawn and the valve 20 closed. Now the minimal amount of fluid within the pressurized lower housing 40 and T-housing 42 can be bled off via the bleed valve 54 to depressurize the lower housing 40 and T-housing 42.

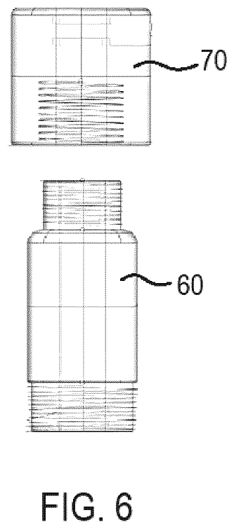

Once the lower housing 40 and T-housing 42 are depressurized or drained the portable hot tapping tool 30 is disengaged from the coupler 22 via untightening of the locking nut 24. The remaining portions of the branch pipe, such as may include wet tap body 60 and coupler 70 (also called a cap) shown in FIG. 6, are now attached the line coupler 22 with the locking nut 24 in conventional fashion. Following the attachment of the remaining portions of the branch pipe (not shown) the valve 20 is again opened thereby creating an entirely new pressurized line or pipeline accessory or the like.

The portable hot tapping tool 30, can be reused with separate saddle clamp 14, leading branch pipe portion 16, valve 20 line coupler 22 and coupling nut 24. Additionally the drill bit can be replaced when worn or to alter the size of the tapped opening.

It will be apparent that various changes to the present invention may be made without departing from the spirit and scope thereof which is defined by the appended claims and equivalents thereto.

What is claimed is:

1. A hot tapping system comprising:
A leading branch pipe portion;
A saddle clamp coupled to the leading branch pipe portion having a saddle-shaped base with a clamp mechanism configured to securely fasten the saddle clamp to a run line, configured to provide a secure and leak-free connection with the leading branch pipe portion;
A valve coupled to the leading branch pipe portion; and
A portable hot tapping tool including a lower housing, intermediate T-housing and upper housing, and a telescoping drive shaft with a drilling bit at a distal end of the telescoping drive shaft for selectively breeching the run line and with a drive connection at a proximal end of the drive shaft, wherein the drive shaft extends longitudinally through the lower housing, intermediate T-housing, and upper housing, with the drive shaft fluidly sealed against the upper housing, whereby only the lower housing and intermediate T-housing is pressurized following breeching of the run line; wherein the lower housing is configured to be selectively coupled to the valve, and wherein the intermediate T-housing includes at least a bleed valve for depressurizing the lower housing and intermediate T-housing following breeching of the run line.

2. The hot tapping system according to claim 1, wherein the drilling bit is a replaceable drilling bit coupled to the end of the drive shaft with a quick release connection.

3. The hot tapping system according to claim 1, further including a line coupler with locking nut coupled to the valve and which is configured to selectively attach the lower housing of the hot tapping tool and to remaining portions of a branch pipe following hot tapping of the run line creating an entirely new pressurized line or pipeline accessory.

4. The hot tapping system according to claim 1, further including a cylindrical bushing within the upper housing through which the drive shaft extends.

5. The hot tapping system according to claim 4, wherein the cylindrical bushing is formed of brass.

6. The hot tapping system according to claim 1, further including a pressure gauge fluidly coupled to the T-housing.

7. The hot tapping system according to claim 6, wherein the T-housing includes an aligned inlet and outlet and a branch line at ninety degrees to the aligned inlet and outlet.

8. The hot tapping system according to claim 7, wherein the drilling bit is a replaceable drilling bit coupled to the end of the drive shaft with a quick release connection.

9. The hot tapping system according to claim 8, further including a line coupler with locking nut coupled to the valve and which is configured to selectively attach the lower housing of the hot tapping tool and to remaining portions of a branch pipe following hot tapping of the run line creating an entirely new pressurized line or pipeline accessory.

10. The hot tapping system according to claim 9, further including a cylindrical bushing within the upper housing through which the drive shaft extends.

11. The hot tapping system according to claim 10, wherein the cylindrical bushing is formed of brass.

12. A portable hot tapping tool comprising:
a lower housing;
an intermediate T-housing including at least a bleed valve;
an upper housing;
a telescoping drive shaft with a drilling bit at a distal end of the telescoping drive shaft for selectively breeching a run line and with a drive connection at a proximal end of the drive shaft, wherein the drive shaft extends longitudinally through the lower housing, intermediate T-housing, and upper housing, with the drive shaft fluidly sealed against the upper housing, whereby only the lower housing and intermediate T-housing is pressurized following breeching of the run line; wherein the lower housing is configured to be selectively coupled to the valve, and wherein the bleed valve is configured for depressurizing the lower housing and intermediate T-housing following breeching of the run line.

13. The hot tapping tool according to claim 12, wherein the drilling bit is a replaceable drilling bit coupled to the end of the drive shaft with a quick release connection.

14. The hot tapping tool according to claim 12, further including a cylindrical bushing within the upper housing through which the drive shaft extends.

15. The hot tapping tool according to claim 14, wherein the cylindrical bushing is formed of brass.

16. The hot tapping tool according to claim 12, further including a pressure gauge fluidly coupled to the T-housing.

17. The hot tapping tool according to claim 16, wherein the T-housing includes an aligned inlet and outlet and a branch line at ninety degrees to the aligned inlet and outlet.

18. The hot tapping tool according to claim 17, wherein the drilling bit is a replaceable drilling bit coupled to the end of the drive shaft with a quick release connection.

19. The hot tapping tool according to claim 18, further including a cylindrical bushing within the upper housing through which the drive shaft extends, and wherein the cylindrical bushing is formed of brass.

20. A method of hot tapping a run line comprising the steps of:
A) Providing a hot tapping system comprising:
i) A leading branch pipe portion;
ii) A saddle clamp coupled to the leading branch pipe portion having a saddle-shaped base with a clamp mechanism;
iii) A valve coupled to the leading branch pipe portion; and
iv) A portable hot tapping tool including a lower housing, intermediate T-housing and upper housing, and a telescoping drive shaft with a drilling bit at a distal end of the telescoping drive shaft for selectively breeching the run line and with a drive connection at a proximal end of the drive shaft, wherein the drive shaft extends longitudinally through the lower housing, intermediate T-housing, and upper housing, with the drive shaft fluidly sealed against the upper housing,
B) securing the leading branch pipe portion tightly to the run pipe exterior with the saddle clamp to provide a secure and leak-free connection with the leading branch pipe portion;
C) securing the valve coupled to the leading branch pipe portion and the portable hot tapping tool to the valve;
D) Operating the hot tapping tool to breach the run pipe, whereby the lower housing and intermediate T-housing is pressurized following breeching of the run line;
E) Closing the valve;
F) Depressurizing the lower housing and intermediate T-housing following breeching of the run line via a bleed line in the T-housing;
G) Removing the portable hot tapping tool from the valve; and
H) Coupling branch pipe elements to the valve and opening the valve.
